(19) United States
(12) Patent Application Publication
(10) Pub. No.: US 2008/0211749 A1
(43) Pub. Date: Sep. 4, 2008

(54) Method for Grayscale Rendition in Am-Oled

(75) Inventors: Sebastien Weitbruch, Kappel (DE); Carlos Correa, Villingen-Schwenningen (DE); Philippe Le Roy, Betton (FR)

Correspondence Address: Joseph J. Laks;Thomson Licensing LLC, 2 Independence Way, Patent Operations, PO Box 5312, PRINCETON, NJ, 08543, US

(73) Assignee: THOMSON LICENSING SA, Boulogne Billancourt (FR)

(21) Appl. No.: 11/587,254

(22) PCT Filed: Apr. 19, 2005
(86) PCT No.: PCT/EP2005/051713

§ 371 Date: Nov. 16, 2007

(30) Foreign Application Priority Data
Apr. 27, 2004 (EP) 04291081.0

(51) Int. Cl. G09G 3/30

(52) U.S. Cl. 345/77

(57) ABSTRACT

The present invention relates to a grayscale rendition method in an active matrix OLED (Organic Light Emitting Display) where each cell of the display is controlled via an association of several Thin-Film Transistors (TFTs). In order to improve the grayscale rendition in an AM-OLED when displaying low grayscale levels and/or when displaying moving pictures, it is proposed to split each frame into a plurality of subframes wherein the amplitude of the data signal applied to a cell of the AM-OLED can be adapted to conform to the visual response of a CRT display. According to the invention, the video frame used for displaying an image is divided into N consecutive subframes, with N≧2, and the data signal applied to the cell comprises N independent elementary data signals, each of said elementary data signals being applied to the cell during a subframe. The grayscale level displayed by the cell during the video frame is depending on the amplitude of the elementary data signals and the duration of the subframes.

The present invention relates to a grayscale rendition method in an active matrix OLED (Organic Light Emitting Display) where each cell of the display is controlled via an association of several Thin-Film Transistors (TFTs). This method has been more particularly but not exclusively developed for video application.

### BACKGROUND

The structure of an active matrix OLED or AM-OLED is well known. It comprises:
an active matrix containing, for each cell, an association of several TFTs with a capacitor connected to an OLED material; the capacitor acts as a memory component that stores a value during a part of the video frame, this value being representative of a video information to be displayed by the cell during the next video frame or the next part of the video frame; the TFTs act as switches enabling the selection of the cell, the storage of a data in the capacitor and the displaying by the cell of a video information corresponding to the stored data;
a row or gate driver that selects line by line the cells of the matrix in order to refresh their content;
a column or source driver that delivers the data to be stored in each cell of the current selected line; this component receives the video information for each cell; and
a digital processing unit that applies required video and signal processing steps and that delivers the required control signals to the row and column drivers.

Actually, there are two ways for driving the OLED cells. In a first way, each digital video information sent by the digital processing unit is converted by the column drivers into a current whose amplitude is proportional to the video information. This current is provided to the appropriate cell of the matrix. In a second way, the digital video information sent by the digital processing unit is converted by the column drivers into a voltage whose amplitude is proportional to the video information. This current or voltage is provided to the appropriate cell of the matrix.

From the above, it can be deduced that the row driver has a quite simple function since it only has to apply a selection line by line. It is more or less a shift register. The column driver represents the real active part and can be considered as a high level digital to analog converter. The displaying of a video information with such a structure of AM-OLED is the following. The input signal is forwarded to the digital processing unit that delivers, after internal processing, a timing signal for row selection to the row driver synchronized with the data sent to the column drivers. The data transmitted to the column driver are either parallel or serial. Additionally, the column driver disposes of a reference signaling delivered by a separate reference signaling device. This component delivers a set of reference voltages in case of voltage driven circuitry or a set of reference currents in case of current driven circuitry. The highest reference is used for the white and the lowest for the smallest gray level. Then, the column driver applies to the matrix cells the voltage or current amplitude corresponding to the data to be displayed by the cells.

Independently of the driving concept (current driving or voltage driving) chosen for the cells, the grayscale level is defined by storing during a frame an analog value in the capacitor of the cell. The cell up to the next refresh coming with the next frame keeps this value. In that case, the video information is rendered in a fully analog manner and stays stable during the whole frame. This grayscale rendition is different from the one in a CRT display that works with a pulse. FIG. 1 illustrates the grayscale rendition in the case of a CRT and an AM-OLED.

FIG. 1 shows that in the case of CRT display (left part of FIG. 1), the selected pixel receives a pulse coming from the beam and generating on the phosphor of the screen a lighting peak that decreases rapidly depending on the phosphor persistence. A new peak is produced one frame later (e.g. 20 ms later for 50 hz, 16.67 ms later for 60 Hz). In this example, a level L1 is displayed during the frame N and a lower level L2 is displayed during a frame N+1. In case of an AMOLED (right part of FIG. 1), the luminance of the current pixel is constant during the whole frame period. The value of the pixel is updated at the beginning of each frame. The video levels L1 and L2 are also displayed during the frames N and N+1. The illumination surfaces for levels L1 and L2, shown by hatched areas in the figure, are equal between the CRT device and the AM-OLED device if the same power management system is used. All the amplitudes are controlled in an analog way.

The grayscale rendition in the AM-OLED has currently some defects. One of them is the rendition of low grayscale level rendition. FIG. 2 shows the displaying of the two extreme gray levels on a 8-bit AM-OLED. This figure shows the difference between the lowest gray level produced by using a data signal C₁ and the highest gray level (for displaying white) produced by using a data signal C₂₅₅. It is obvious that the data signal C₁ must be much lower than C₂₅₅. C₁ should normally be 255 times as low as C₂₅₅. So, C₁ is very low. However, the storage of such a small value can be difficult due to the inertia of the system. Moreover, an error in the setting of this value (drift . . . ) will have much more impact on the final level for the lowest level than for the highest level.

Another defect of the AM-OLED appears when displaying moving pictures. This defect is due to the reflex mechanism, called optokinetic nystagmus, of the human eyes. This mechanism drives the eyes to pursue a moving object in a scene to keep a stationary image on the retina. A motion-picture film is a strip of discrete still pictures that produces a visual impression of continuous movement. The apparent movement, called visual phi phenomenon, depend on persistence of the stimulus (here the picture). FIG. 3 illustrates the eye movement in the case of the displaying of a white disk moving on a black background. The disk moves towards left from the frame N to the Frame N+1. The brain identifies the movement of the disk as a continuous movement towards left and creates a visual perception of a continuous movement. The motion rendition in an AM-OLED conflicts with this phenomenon, unlike the CRT display. The perceived movement with a CRT and an AM-OLED when displaying the frame N and N+1 of FIG. 3 is illustrated in FIG. 4. In the case of a CRT display, the pulse displaying suits very well to the visual phi phenomenon. Indeed, the brain has no problem to identify the CRT information as a continuous movement. However, in the case of the AM-OLED picture rendition, the object seems to stay stationary during a whole frame before jumping to a new position in the next frame. Such a movement is quite difficult to be interpreted by the brain that results in either blurred pictures or vibrating pictures (judder).

It is an object of the present invention to disclose a method and an apparatus for improving the grayscale rendition in an AM-OLED when displaying low grayscale levels and/or when displaying moving pictures.

In order to solve these problems, it is proposed to split each frame into a plurality of subframes wherein the amplitude of the signal can be adapted to conform to the visual response of a CRT display.

The invention concerns a method for displaying an image in an active matrix organic light emitting display comprising a plurality of cells, a data signal being applied to each cell for displaying a grayscale level of a pixel of the image during a video frame, characterized in that the video frame is divided into N consecutive subframes, with N≧2, and in that the data signal of a cell comprises N independent elementary data signals, each of said elementary data signals being applied to the cell during a subframe and the grayscale level displayed by the cell during the video frame depending on the amplitude of the elementary data signals and the duration of the subframes and in that the duration of the subframes is increasing from the first subframe to the last subframe of the video frame and, for each grey level, the amplitude of the elementary data signals is decreasing from the first subframe to the last subframe of the video frame.

The amplitude of each elementary data signal is either greater than a first threshold for emitting light or equal to an amplitude C_{black} less than the first threshold for disabling light emission. This first threshold is the same value for each subframe.

The amplitude of each elementary data signals is furthermore less than or equal to a second threshold.

In a first embodiment, this second threshold is different for each subframe and is decreasing from the first subframe to the last subframe of the video frame. In said first embodiment, for each one of a plurality of reference grayscale levels, the amplitude of the elementary data signals used for displaying said reference grayscale levels which are different from the amplitude C_{black} can be defined as cut-off amplitudes and then, for displaying the next higher grayscale level to said reference grayscale levels in the range of possible grayscale levels, the amplitude of each of said elementary data signals is lowered from an amount such that the amplitude of the first next elementary data signals is increased from an amount greater than the first threshold.

In a second embodiment, the second threshold is the same value in each subframe of the video frame and is equal to C₂₅₅. In said second embodiment, the grayscale levels for which the amplitude of the elementary data signals used for displaying said grayscale levels are equal to either said second threshold or C_{black} are defined as reference grayscale levels. For displaying the next higher grayscale level to said reference grayscale levels in the range of possible grayscale levels, the amplitude of at least one of the elementary data signals equal to the second threshold is lowered from an amount such that the amplitude of the first next elementary data signals is increased from an amount greater than the first threshold.

Advantageously, the inventive method comprises also the following steps for generating motion compensated images:
calculating a motion vector for at one pixel of the image;
calculating a shift value for each subframe and for said at least one pixel in accordance with the motion vector calculated for said pixel; and
processing the data signal of the cell used for displaying said at least one pixel in accordance with the shift value calculated for said pixel.

In the invention, it is possible to redistribute the energy of the elementary data signal for displaying a grayscale level of said at least one pixel during a subframe to cells of the display in accordance with the shift value for said at least one pixel and said subframe.

The invention concerns also an apparatus for displaying an image comprising an active matrix comprising a plurality of organic light emitting cells, a row driver for selecting line by line the cells of said active matrix, a column driver for receiving data signals to be applied to the cells for displaying grayscale levels of pixels of the image during a video frame, and a digital processing unit for generating said data signals and control signals to control the row driver. This apparatus is characterized in that the video frame is divided into N consecutive subframes and the duration of the subframes is increasing from the first subframe to the last subframe of the video frame, with N≧2, and in that the digital processing unit generates data signal each comprising N independent elementary data signals such that, for each grey level, the amplitude of the elementary data signals is decreasing from the first subframe to the last subframe of the video frame, each of said elementary data signals being applied via the column driver to a cell during a subframe, the grayscale level displayed by the cell during the video frame depending on the amplitude of the elementary data signals and the duration of the subframes.

### BRIEF DESCRIPTION OF THE DRAWINGS

Exemplary embodiments of the invention are illustrated in the drawings and in more detail in the following description.

In the figures:

FIG. 1 shows the illumination during frames in the case of a CRT and an AM-OLED;

FIG. 2 shows the data signal applied to a cell of the AM-OLED for displaying two extreme grayscale levels in a classical way;

FIG. 3 illustrates the eye movement in the case of a moving object in a sequence of images;

FIG. 4 illustrates the perceived movement of the moving object of FIG. 3 in the case of a CRT and an AM-OLED;

FIG. 5 illustrates the method of the invention in a general way;

FIG. 6 illustrates the elementary data signals applied to a cell for displaying different grayscale levels according two embodiments of the invention;

FIG. 7 illustrates the displaying of specific grayscale levels according to the first embodiment of the invention;

FIG. 8 illustrates the displaying of specific grayscale levels according to the second embodiment of the invention;

FIG. 9 shows the positions during each subframe of a pixel moving according to a motion vector between two frames;

FIG. 10 shows the position of the pixel of FIG. 9 during the seventh subframe of a video frame;

FIG. 11 illustrates an embodiment of the invention in the case of a PC application;

FIG. 12 shows a first apparatus wherein the inventive method is implemented; and

FIG. 13 shows a second apparatus wherein the inventive method is implemented.

### DESCRIPTION OF PREFERRED EMBODIMENTS

According to the invention, the video frame is divided in a plurality of subframes wherein the amplitude of the data signal applied to the cell is variable and the data signal of a cell comprises a plurality of independent elementary data signals, each of these elementary data signals being applied to the cell during a subframe. The number of subframes is higher than two and depends on the refreshing rate that can be used in the AMOLED.

In the present specification, the following notations will be used:
C_{L} designates the amplitude of the data signal of a cell for displaying a grayscale level L in a conventional method like in FIG. 2;
SFᵢ designates the i^{th} subframe in a video frame;
C′(SFᵢ) designates the amplitude of the elementary data signal for a subframe SFᵢ of the video frame;
Dᵢ designates the duration of the subframe SFᵢ;
Cₘᵢₙ is a first threshold that represents a value of the data signal above which the working of the cell is considered as good (fast write, good stability . . . );
C_{black} designates the amplitude of the elementary data signal to be applied to a cell for disabling light emission; C_{black} is lower than Cₘᵢₙ.

FIG. 5 can illustrate the method of the invention. In this example, the original video frame is divided into 6 subframes SF₁ to SF₆ with respective durations D₁ to D₆. 6 independent elementary data signals C′(SF₁), C′(SF₂), C′(SF₃), C′(SF₄), C′(SF₅) and C′(SF₆) are used for displaying a grayscale level respectively during the subframes SF₁, SF₂, SF₃, SF₄, SF₅ and SF₆.

Some parameters have to be defined for each subframe:
a second threshold, called value Cₘₐₓ(SFᵢ), that represents the maximum data value during the subframe SFᵢ; and
the duration Dᵢ of the subframe SFᵢ, I_{ε}[0 . . . 5].

In the invention, the amplitude of each elementary data signal C′(SFᵢ) is either C_{black} or higher than Cₘᵢₙ. Furthermore, C′(SFᵢ₊₁)≦C′(SFᵢ) in order to avoid moving artifacts as known for the PDP technology.

The durations Di of the subframes SFᵢ are defined to meet the following conditions:
D₁×Cₘᵢₙ<C₁×T where T represents the video frame duration; this condition ensures that the lowest grayscale level can be rendered with a data signal above the threshold Cₘᵢₙ; the surface C×T represents the lowest grayscale level and it is possible to find a new C′(SF₁) so that we have: D₁×C′(SF₁)=C₁×T with C′(SF₁)>Cₘᵢₙ.
For all Dᵢ with i>1, D>Dᵢ₋₁ and Dᵢ×Cₘᵢₙ<Dᵢ₋₁×Cₘₐₓ(SFᵢ₋₁); this condition ensures that it is possible to have continuity in the grayscale rendition by always adding subframes.

The invention will be described by two main embodiments. In a first embodiment, Cₘₐₓ(SFᵢ) is decreasing from one subframe to the next one in the video frame and the value Cₘₐₓ for the first subframes of the video frame is higher than C₂₅₅. In a second embodiment, Cₘₐₓ(SFᵢ) is the same value for all subframes and equals to the value C₂₅₅ of FIG. 2.

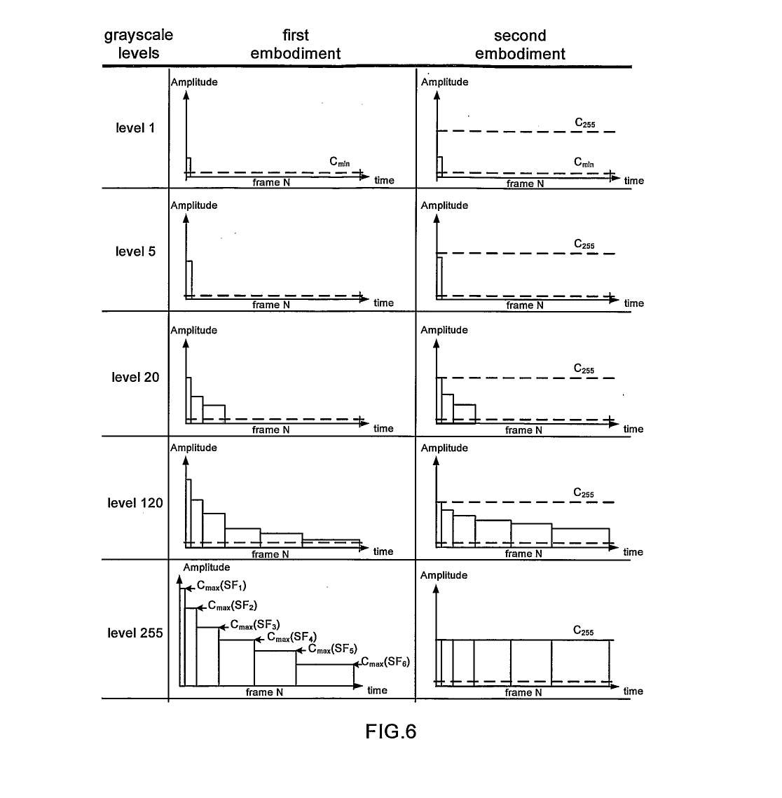

FIG. 6 is a table illustrating the two embodiments. The first embodiment is detailed in a first column of the table and the second embodiment in a second one. This table shows the amplitude of the elementary data signals to be applied to a cell for displaying the grayscale levels 1, 5, 20, 120 and 255 in the two embodiments.

In the first embodiment, the second thresholds Cₘₐₓ(SFᵢ) are defined such that

$${\sum }_{i = 1}^{6} {C}_{max} ( {SF}_{i} ) \cdot {D}_{i} = {C}_{255} \cdot {\sum }_{i = 1}^{6} {D}_{i}$$

In the second embodiment, Cₘₐₓ(SFᵢ) is the same value for the 6 subframes and equals to C₂₅₅.

In these two embodiments, the amplitudes C′(SFᵢ)ᵢε_{[106]} for displaying the grayscale levels 1, 5, 20, 120 and 255 are the following ones:
for level 1, C′(SF₁)>Cₘᵢₙ and C′(SFᵢ)=C_{black} for i_{ε}[206];
for level 5, C′(SF₁)>Cₘᵢₙ and C′(SFᵢ)=C_{black} for i_{ε}[206];
for level 20, C′(SF₁)>C′(SF₂)>C′(SF₃)>Cₘᵢₙ and C′(SFᵢ)=C_{black} for i_{ε}[406];
for level 120, C′(SF₁)>C′(SF₂)>C′(SF₃)>C′(SF₄)>C′(SF₅)>C′(SF₆)>Cₘᵢₙ
for level 255, C′(SF₁)>C′(SF₂)>C′(SF₃)>C′(SF₄)>C′(SF₅)>C′(SF₆)>Cₘᵢₙ in the first embodiment and C′(SFᵢ)=C₂₅₅ for i_{ε}[1□6] in the second embodiment;

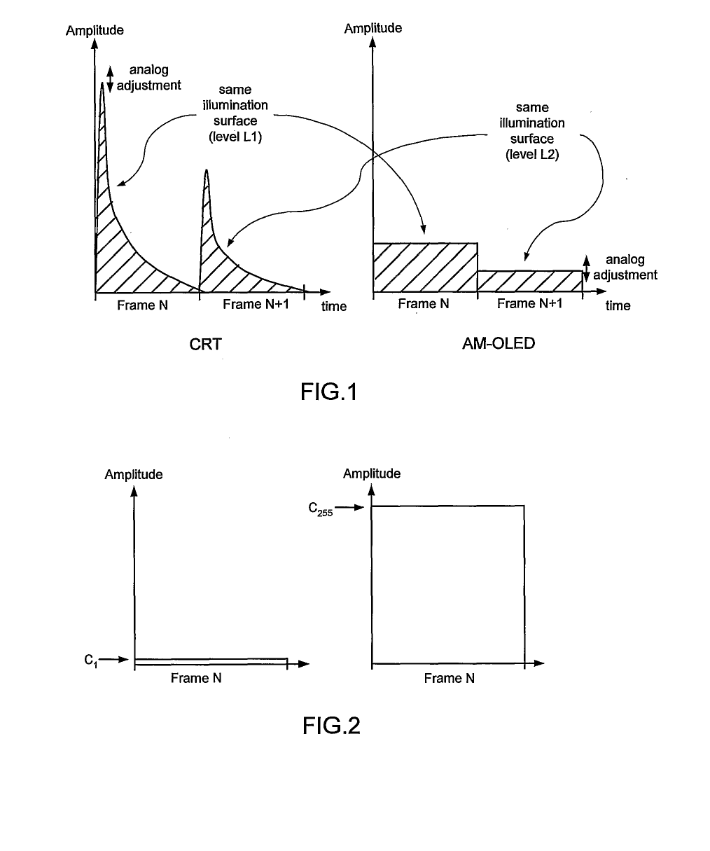

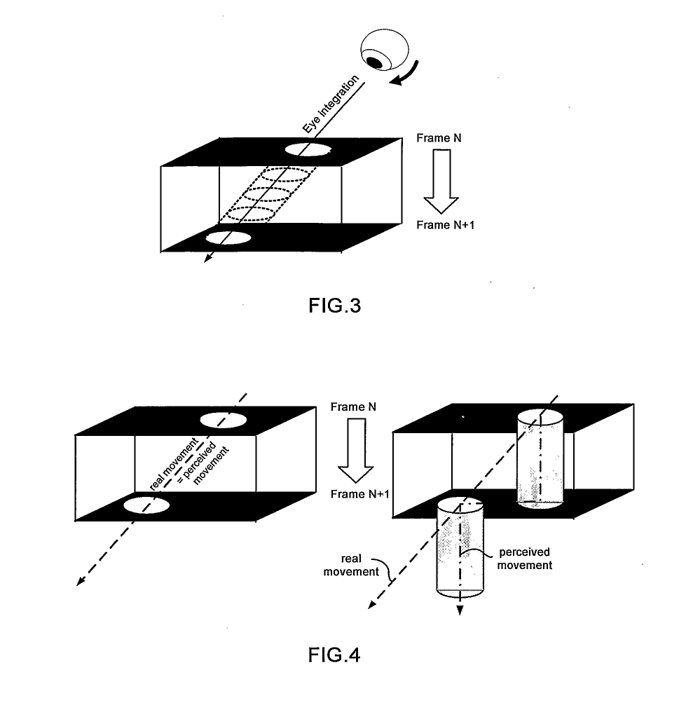

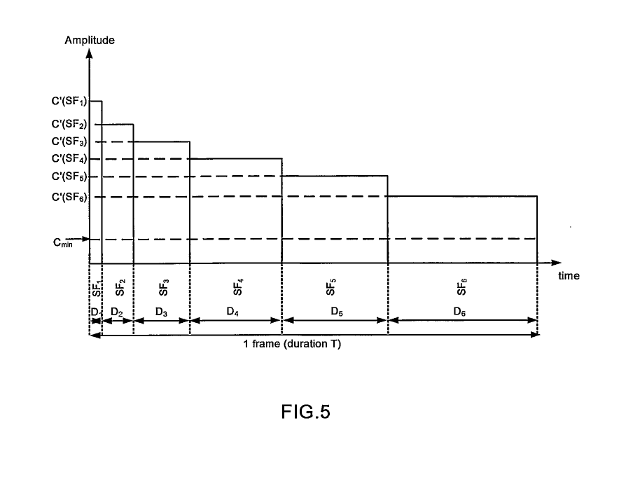

C′(SFᵢ₊₁) is preferably lower than C′(SFᵢ), as in the first embodiment, in order to avoid moving artifacts as known for the PDP technology. Consequently, the light emission in the first embodiment is similar to the one with a cathode ray tube (CRT) presented in FIG. 1 whereas, in the second embodiment, the light emission is similar to the one with a CRT only for the first half of the grayscale levels (low levels to middle levels).

Concerning the low level rendition, both embodiments are equivalent. As the first elementary data signal is not applied to the cell during the entire video frame, it can be higher than the threshold Cₘᵢₙ. Besides, these embodiments are identical for the rendition of low level up to mid grayscale.

Concerning the motion rendition, the first embodiment offers a better motion rendition than conventional methods because the second threshold for the last subframes of the video frame is less than C₂₅₅. This motion rendition is better for all the grayscale levels. For the second embodiment, the motion rendition is only improved for the low levels up to the midlevels.

It appears that the first embodiment is more adapted for improving low-level rendition and motion rendition. However, as the maximal data signal amplitude Cₘₐₓ used for the first subframes is much higher than the usual one C₂₅₅, it could have an impact on the cell lifetime. So, this last parameter must be taken into account for selecting one of these embodiments.

The invention presents another advantage: the resolution of the grayscale levels is increased. Indeed, the analog amplitude of an elementary data signal to be applied to a cell is defined by a column driver. If the column driver is a 6-bit driver, the amplitude of each elementary data signal is 6-bit. As 6 elementary data signals are used, the resolution of the resulting data signal is higher than 6 bits.

In an improved embodiment, for displaying a given grayscale level, it is possible to lower the amplitude of one of the elementary data signals used for displaying the preceding lower grayscale level in the possible grayscale levels range in order to be sure that the amplitudes of all elementary data signals different from C_{black} are greater than Cₘᵢₙ. The main idea behind this improvement is that, when a new subframe is used, the former value of the previous ones should be reduced accordingly so that the amplitude of the new non-zero elementary data signal is necessarily above Cₘᵢₙ.

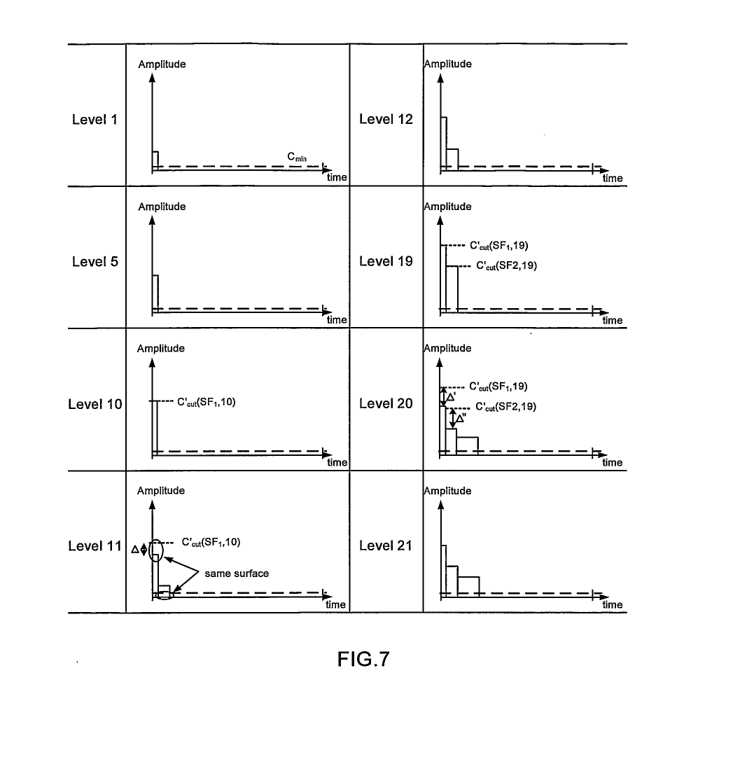

FIG. 7 illustrates this improvement for the first embodiment. For displaying the first low level, the amplitudes of the elementary data signals are the following ones:
C′(SF₁)=A>C
C′(SFᵢ)=C_{black} for all i>1.

For the first further grayscale levels, the value of C′(SF₁) increases while keeping C′(SFᵢ)=C_{black} for all i>1. For some reference grayscale levels, like for example 10 or 19, the amplitudes of the elementary data signals different from C_{black} are considered as cut-off amplitudes. They are referenced C′_{cut}(SFᵢ,L) for the subframe SFi and the reference grayscale level L. For example, for displaying the grayscale level 10, we have:
C′(SF₁)=C′_{cut}(SF₁,10)
C′(SFᵢ)=C_{black} for all i>1.

For displaying the grayscale level 11, the amplitude C′(SF₁) is lowered in order that the amplitude of the next elementary data signal, C′(SF₂), be greater than Cₘᵢₙ. Preferably, the amplitude C′(SF1) is lowered from an amount Δ such that Δ×D₁=Cₘᵢₙ×D₂.
C′(SF₁)=C′_{cut}(SF₁,10)−Δ=C′_{cut}(SF₁,10)−(Cₘᵢₙ×D₂)/D₁
C′(SF₂)>Cₘᵢₙ
C′(SFᵢ)=C_{black} for all i>2.

In the same manner, for displaying the grayscale level 19, we have:
C′(SF₁)=C′_{cut}(SF₁,19)
C′(SF₂)=C′_{cut}(SF₂,19)
C′(SFᵢ)=C_{black} for all i>2.

For displaying the grayscale level 20, the amplitudes C′(SF₁) and C′(SF₂) are lowered in order that the amplitude of the next elementary data signal, C′(SF₃), be greater than Cₘᵢₙ. The amplitudes C′(SF₁) and C′(SF₂) are preferably lowered respectively from an amount Δ′ and Δ″ such that Δ′×D₁+Δ″×D₂=Cₘᵢₙ×D₃.
C′(SF₁)=C′_{cut}(SF₁,19)−Δ′
C′(SF₂)=C′_{cut}(SF₂,19)−Δ″
C′(SF₃)>Cₘᵢₙ
C′(SFᵢ)=C_{black} for all i>3.

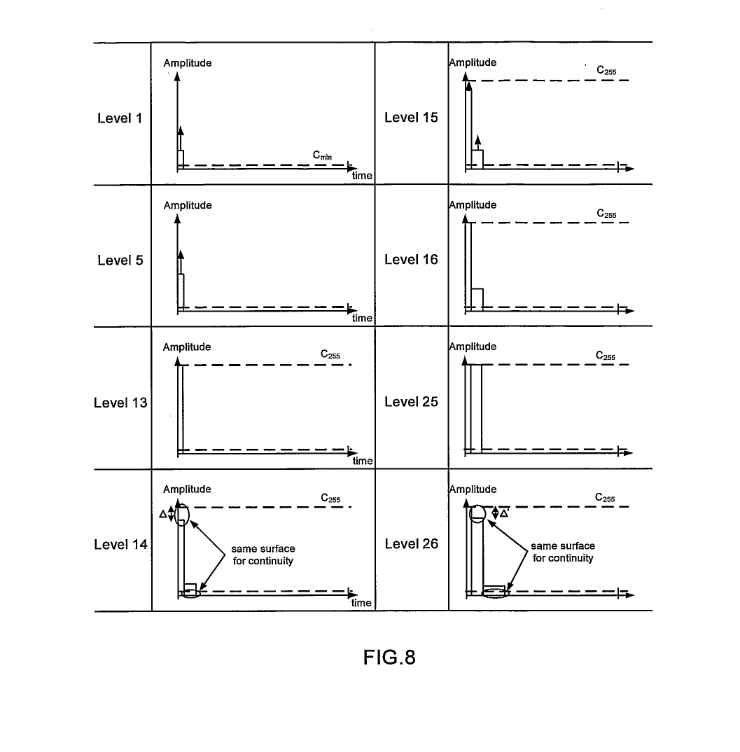

FIG. 8 illustrates this improvement for the second embodiment. For displaying the first low level, it is like for the first embodiment:
C′(SF₁)=A>C
C′(SFᵢ)=C_{black} for all i>1.

For the first further grayscale levels, the value of C′(SF₁) increases while keeping C′(SFᵢ)=C_{black} for all i>1. When the amplitude of an elementary data signal C(SFᵢ) reaches C₂₅₅ for displaying a grayscale level L, the amplitude of this elementary data signal is lowered for displaying the level L+1. It is lowered preferably from an amount Δ such that Δ×Dᵢ=Cₘᵢₙ×Dᵢ₊₁.

It is illustrated in FIG. 8 for the levels 14, 15, 25 and 26. For the level 13, we have C′(SF₁)=C₂₅₅ and C′(SFᵢ)=C_{black} for all i>1. For the level 14, we have
C′(SF₁)=C₂₅₅−Δ=C₂₅₅−(Cₘᵢₙ×D₂)/D₁
C′(SF₂)>Cₘᵢₙ
C′(SFᵢ)=C_{black} for all i>2.

In the same manner, for displaying the level 25, we have C′(SF₁)=C′(SF₂)=C₂₅₅ and C′(SF₁)=C_{black} for all i>2. For the level 26, we have
C′(SF₁)=C₂₅₅
C′(SF₂)=C₂₅₅−Δ′=C₂₅₅−(Cₘᵢₙ×D₃)/D₂
C′(SF₃)>Cₘᵢₙ
C′(SFᵢ)=C_{black} for all i>3.

The method of the invention can be advantageously used when using a motion estimation for generating motion compensated images. The motion estimator generates a motion vector for each pixel of the picture, this vector representing the motion of the pixel from one frame to the next one. Based on this movement information, it is possible to compute a shift value for each subframe and each pixel of the image. Then the data signal of the cells can be processed in accordance with these shift values for generating a motion compensated image. Contrary to the driving method used in a PDP, the analog value of the elementary data signal for a subframe can be adjusted if the displacement of a pixel for said subframe does not coincide with the position of a cell of the AMOLED. By knowing the real displacement of the pixel, it is possible to interpolate a new analog value for the elementary data signal of said subframe depending on its temporal position.

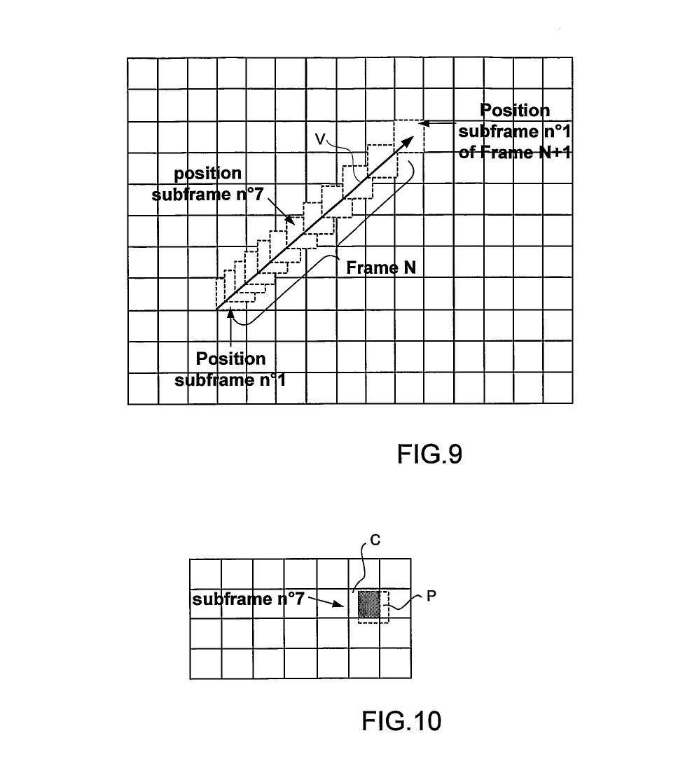

This improvement is illustrated by FIGS. 9 and 10. FIG. 9 shows the different positions of a pixel during a video frame N comprising 11 subframes according to a motion vector V. As the amplitude of the elementary data signal of each subframe is analog, it is possible to modify its value in order to obtain a better image corresponding to the temporal position of this subframe. For example, as illustrated by FIG. 10, the energy of a pixel P for the seventh subframe is distributed on 4 cells of the AMOLED. According to the invention, an interpolation can be done in an analog way by distributing to each of the four cells a part of the energy of the pixel proportional to the area of pixel recovering said cell.

In FIG. 10, the position of the pixel P does not coincide exactly with the position of a cell C of the AM-OLED. The hatched area represents the area of the pixel P that coincides with the cell C. This area equals to x % of the pixel area. So, for a good interpolation, x % of the energy of the pixel P is transferred to the cell C and the rest is either suppressed or distributed to the 3 other cells.

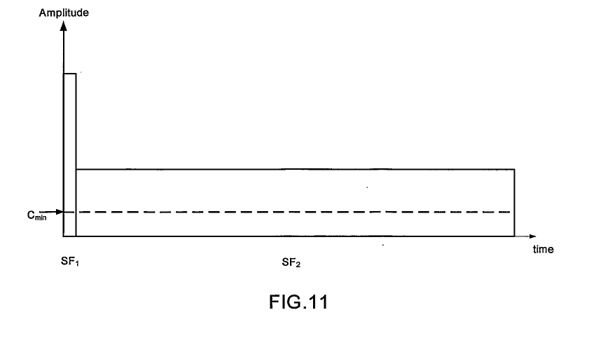

The principle of the invention is applicable to video or PC applications. For PC applications, it is possible to use only 2 subframes in the main frame, a first subframe having a low duration and a second one having a higher duration as shown in FIG. 11. There is no need for more subframes because there are no moving sequences and these two subframes are enough for improving the low level rendition.

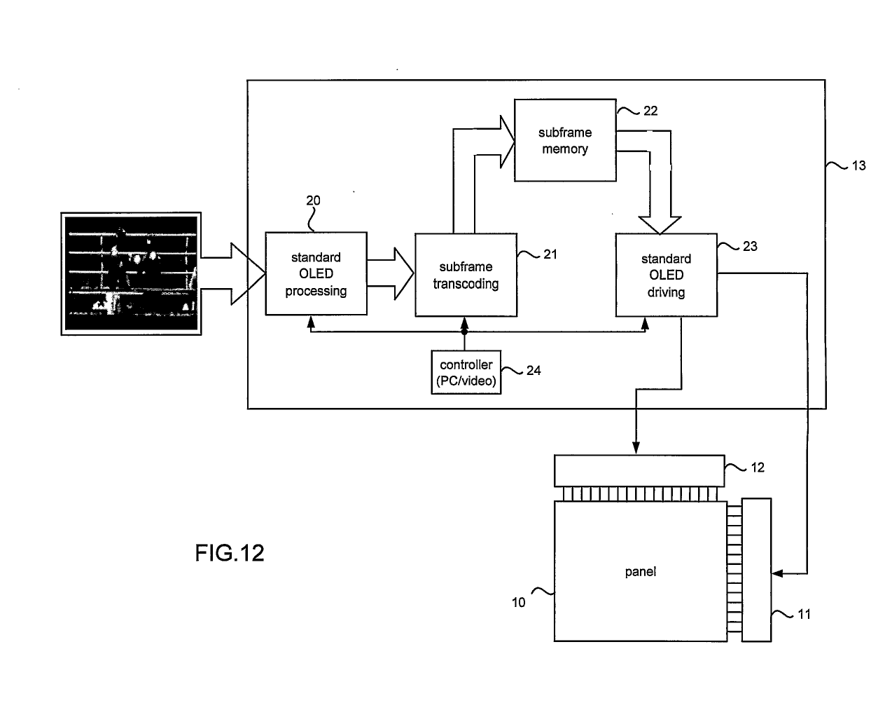

Different devices can be used for implementing the inventive method. FIG. 12 shows a first device. It comprises an AM-OLED 10, a row driver 11 that selects line by line the cells of the AM-OLED 10 in order to refresh their content, a column driver 12 that receives a video information for each cell of the AM-OLED and delivers a data representative of the video information to be stored in the cell, and a digital processing unit 13 that delivers appropriate data signals to the row driver 11 and video information to the column driver 12.

In the digital processing unit 13, the video information are forwarded to a standard OLED processing block 20 as usual. The output data of this block are then forwarded to a subframe transcoding table 21. This table delivers n output data for each pixel, n being the number of subframes and one output data for each subframe. The n output data for each pixel are then stored at different positions in a subframe memory 22, a specific area in the memory being allocated for each subframe. The subframe memory 22 is able to store the subframe data for 2 images. The data of one image can be written while the data of the other image are read. The data are read subframe by subframe and transmitted to a standard OLED driving unit 23.

The OLED driving unit 23 is in charge of driving subframe by subframe the row driver 11 and the column driver 12. It controls also the duration D of the sub-frames.

A controller 24 may be used for selecting a video display mode wherein the images are displayed with a plurality of subframes and a PC display mode wherein the images are displayed with one single subframe (as usual) or with two subframes for improving low level rendition. The controller 24 is connected to the OLED processing block 20, the subframe transcoding table 21 and the OLED driving unit 23.

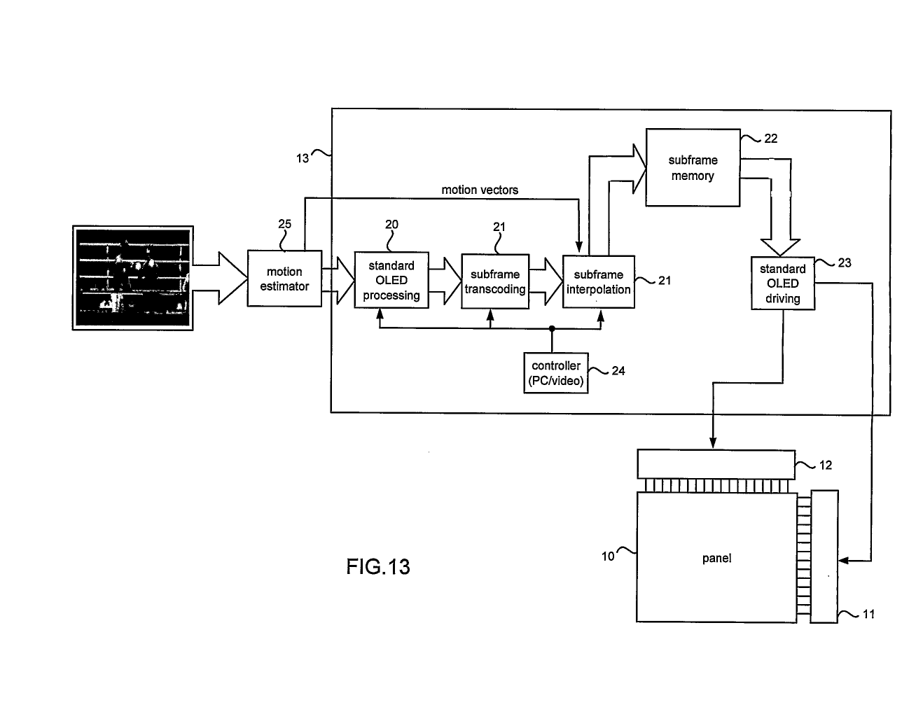

FIG. 13 illustrates another embodiment with motion estimation. The digital processing unit 13 comprises the same blocks, only with a motion estimator 25 before the OLED processing unit 20 and a subframe interpolation block 26 inserted between the subframe transcoding table 21 and the subframe memory 26. The input signal is forwarded to the motion estimator 26 that computes a motion vector per pixel or group of pixels of the current image. Then, the input signal is further sent to the OLED processing 20 and the subframe transcoding table 21 as explained before. The motion vectors are sent to the subframe interpolation block 26. They are used with the previous subframes coming from the subframe transcoding table 21 for producing new subframes.

1. Method for displaying an image in an active matrix organic light emitting display comprising a plurality of cells, a data signal being applied to each cell for displaying a grayscale level of a pixel of the image during a video frame, wherein the video frame is divided into N consecutive subframes, with N≧2, and in that the data signal of a cell comprises N independent elementary data signals, each of said elementary data signals being applied to the cell during a subframe and the grayscale level displayed by the cell during the video frame depending on the amplitude of the elementary data signals and the duration of the subframes and the duration of the subframes is increasing from the first subframe to the last subframe of the video frame and, for each grey level, the amplitude of the elementary data signals is decreasing from the first subframe to the last subframe of the video frame.

2. Method according to claim 1, wherein the amplitude of each elementary data signal is either greater than a first threshold for emitting light or equal to an amplitude C_{black} less than the first threshold for disabling light emission.

3. Method according to claim 2, wherein the first threshold is the same value for each subframe.

4. Method according to claims 1, wherein the amplitude of each elementary data signals is less than or equal to a second threshold.

5. Method according to claim 4, wherein said second threshold is different for each subframe and is decreasing from the first subframe to the last subframe of the video frame.

6. Method according to claim 5, wherein for each one of a plurality of reference grayscale levels, the amplitude of the elementary data signals used for displaying said reference grayscale levels which are different from the amplitude C_{black} are defined as cut-off amplitudes and wherein, for displaying the next higher grayscale level to said reference grayscale levels in the range of possible grayscale levels, the amplitude of each of said elementary data signals is lowered from an amount such that the amplitude of the first next elementary data signals is increased from an amount greater than the first threshold.

7. Method according to claim 4, wherein said second threshold is the same value in each subframe of the video frame.

8. Method according to claim 7, wherein the grayscale levels for which the amplitude of the elementary data signals used for displaying said grayscale levels are equal to either said second threshold or C_{black} are defined as reference grayscale levels and wherein, for displaying the next higher grayscale level to said reference grayscale levels in the range of possible grayscale levels, the amplitude of at least one of the elementary data signals equal to the second threshold is lowered from an amount such that the amplitude of the first next elementary data signals is increased from an amount greater than the first threshold.

9. Method according to claims 1,
wherein it further comprises the following steps:
calculating a motion vector for at one pixel of the image;
calculating a shift value for each subframe and for said at least one pixel in accordance with the motion vector calculated for said pixel; and
processing the data signal of the cell used for displaying said at least one pixel in accordance with the shift value calculated for said pixel.

10. Method according to claim 9, wherein the energy of the elementary data signal for displaying a grayscale level of said at least one pixel during a subframe is distributed to cells of the display in accordance with the shift value for said at least one pixel and said subframe.

11. Apparatus for displaying an image comprising
an active matrix comprising a plurality of organic light emitting cells,
a row driver for selecting line by line the cells of said active matrix
a column driver for receiving data signals to be applied to the cells for displaying grayscale levels of pixels of the image during a video frame, and
a digital processing unit for generating said data signals and control signals to control the row driver
wherein the video frame is divided into N consecutive subframes and the duration of the subframes is increasing from the first subframe to the last subframe of the video frame, with N≧2, and the digital processing unit generates data signal each comprising N independent elementary data signals such that, for each grey level, the amplitude of the elementary data signals is decreasing from the first subframe to the last subframe of the video frame, each of said elementary data signals being applied via the column driver to a cell during a subframe, the grayscale level displayed by the cell during the video frame depending on the amplitude of the elementary data signals and the duration of the subframes.

12. Apparatus according to claim 11, characterized wherein it further comprises a motion estimator for calculating a motion vector for at one pixel of the image, and
the digital processing unit is capable of calculating a shift value for each subframe and for said at least one pixel in accordance with the motion vector calculated for said pixel and processing the data signal of the cell used for displaying said at least one pixel in accordance with the shift value calculated for said pixel.

13. Apparatus according to claim 12, wherein the digital processing unit is capable of distributing the energy of the elementary data signal for displaying a grayscale level of said at least one pixel during a subframe to cells of the display in accordance with the shift value for said at least one pixel and said subframe.
